(19) United States
(12) Patent Application Publication
(10) Pub. No.: US 2014/0060919 A1
(43) Pub. Date: Mar. 6, 2014

(54) ATTACHMENT STRUCTURE OF ELECTRICAL EQUIPMENT ACCOMMODATION BOX

(71) Applicant: SUZUKI MOTOR CORPORATION, Hamamatsu-shi (JP)

(72) Inventors: Tomohiro Sudo, Hamamatsu-shi (JP); Kotaro Kurita, Hamamatsu-shi (JP)

(73) Assignee: SUZUKI MOTOR CORPORATION, Hamamatsu-shi (JP)

(21) Appl. No.: 14/011,371

(22) Filed: Aug. 27, 2013

(30) Foreign Application Priority Data
Aug. 31, 2012 (JP) 2012-191268

(51) Int. Cl. B60R 11/00

(52) U.S. Cl. CPC B60R 11/00
USPC 174/520

(57) ABSTRACT

There is provided an attachment structure of an electrical equipment accommodation box in which an electrical equipment accommodation box accommodating therein an electrical component is attached to a wall surface of a vehicle body-side by a bracket. The bracket has a receptacle shape in which a bottom part is formed at a side facing the wall surface. The bottom part of the bracket is provided with a connection part for connecting the bracket and the wall surface each other.

### CROSS-REFERENCE TO RELATED APPLICATIONS

This application claims the benefit of Japanese Patent Application No. 2012-191268, filed Aug. 31, 2012, in the Japanese Patent Office. All disclosures of the document(s) named above are incorporated herein by reference.

### BACKGROUND OF THE INVENTION

1. Field of the Invention

The invention relates to an attachment structure of an electrical equipment accommodation box, and more particularly, to an attachment structure of an electrical equipment accommodation box with which an electrical equipment accommodation box, which accommodates therein electrical components such as an electronic board, a power divider dividing current flowing through electric wires provided to a vehicle, and the like, is attached on a wall surface of a vehicle body-side.

2. Description of the Related Art

As an attachment structure of an electrical equipment accommodation box of a vehicle, a structure has been known in which upper and lower parts of an electrical equipment accommodation box are respectively fixed to a wall surface of a vehicle body interior panel, which is a wall surface of a vehicle body-side, by brackets. A following prior art document discloses an attachment structure of an electrical component.

Patent Document 1: JP-A-2011-152846

In a flooding preventing structure of an electrical component disclosed in Patent Document 1, an upper side of the bracket is formed with a step part for drainage and water droplets that are transferred along the bracket are prevented from being attached to an electrical component.

In Patent Document 1, the brackets should be respectively disposed at the upper and lower parts so as to fix the electrical component to the wall surface of the vehicle body interior panel, and a space necessary for attachment of the electrical component is increased.

### SUMMARY OF THE INVENTION

It is therefore an object of the present invention to provide an attachment structure of an electrical equipment accommodation box capable of attaching an electrical component to a wall surface of a vehicle body-side without increasing a space.

In order to achieve the above object, according to an aspect of the embodiments of the present invention, there is provided an attachment structure of an electrical equipment accommodation box in which a electrical equipment accommodation box accommodating therein an electrical component is attached to a wall surface of a vehicle body-side by a bracket, wherein the bracket has a receptacle shape in which a bottom part is formed at a side facing the wall surface, and wherein the bottom part of the bracket is provided with a connection part for connecting the bracket and the wall surface each other.

According to the invention, it is possible to attach an electrical component to a wall surface of a vehicle body-side without increasing a space.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a front view showing a state where an electrical equipment accommodation box is mounted to a vehicle interior panel (an illustrative embodiment).

FIG. 2 is a bottom view showing a state where the electrical equipment accommodation box is mounted to the vehicle interior panel, which is seen from an arrow II of FIG. 1 (an illustrative embodiment).

FIG. 3 is a left side view showing a state where the electrical equipment accommodation box is mounted to the vehicle interior panel, which is seen from an arrow III of FIG. 1 (an illustrative embodiment).

FIG. 4 is a right side view showing a state where the electrical equipment accommodation box is mounted to the vehicle interior panel, which is seen from an arrow IV of FIG. 1 (an illustrative embodiment).

FIG. 5 is a perspective view of a bracket (an illustrative embodiment).

FIG. 6 is a perspective view of the electrical equipment accommodation box (an illustrative embodiment).

FIG. 7 is a front view seen from the bracket at a state where the electrical equipment accommodation box is mounted to the bracket (an illustrative embodiment).

FIG. 8 is a perspective view seen from the bracket at a state where the electrical equipment accommodation box is mounted to the bracket (an illustrative embodiment).

FIG. 9 is a perspective view seen from the electrical equipment accommodation box at a state where the electrical equipment accommodation box is mounted to the bracket (an illustrative embodiment).

FIG. 10 is a front view of an upper engagement mechanism (an illustrative embodiment).

FIG. 11 is a front view of a lower engagement mechanism (an illustrative embodiment).

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The invention realizes an object of attaching an electrical component to a wall surface of a vehicle body-side without increasing a space by providing a connection part, which connects a bracket and the wall surface of the vehicle body-side each other, to a bottom part of the bracket.

### Illustrative Embodiment

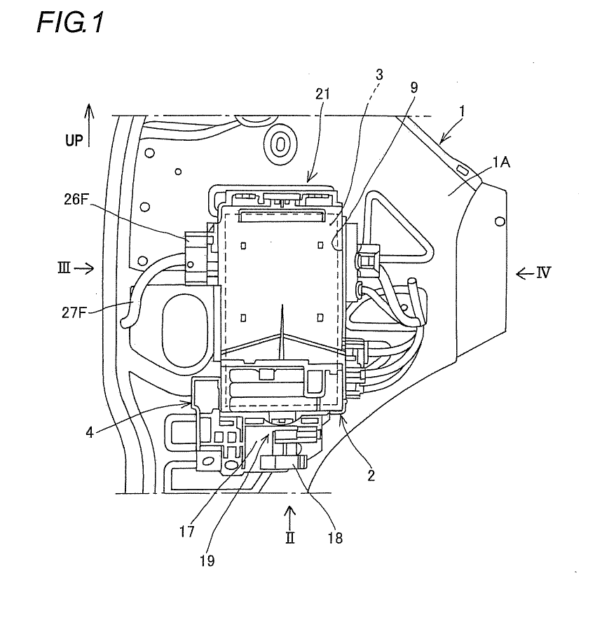

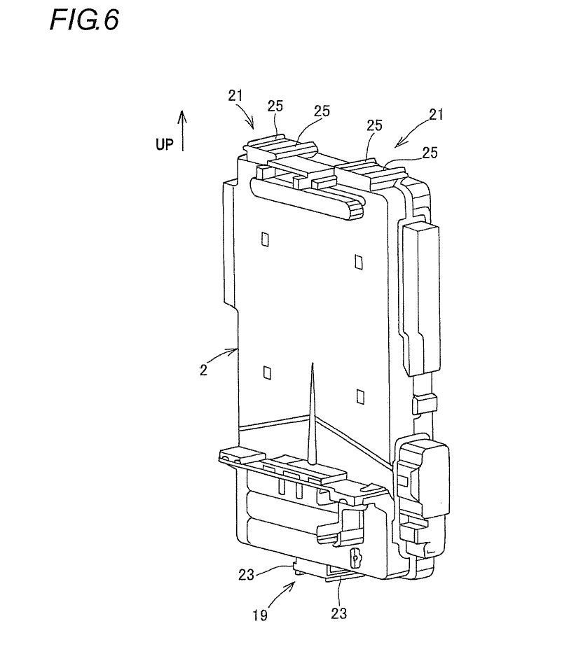

FIGS. 1 to 11 show an illustrative embodiment of the invention. As shown in FIGS. 1 to 4, a vehicle is provided with a vehicle interior panel 1. An electrical equipment accommodation box 2 is attached to the vehicle interior panel 1. The electrical equipment accommodation box 2 is to accommodate an entire electrical component 3 such as an electronic board, a power divider dividing current flowing through electric wires provided to the vehicle, and the like. The electrical equipment accommodation box 2 is attached to a wall surface 1A of the vehicle interior panel 1, which is a wall surface of a vehicle body-side, by a bracket 4.

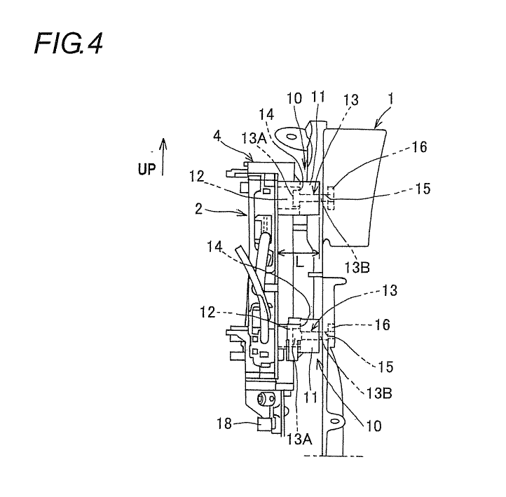

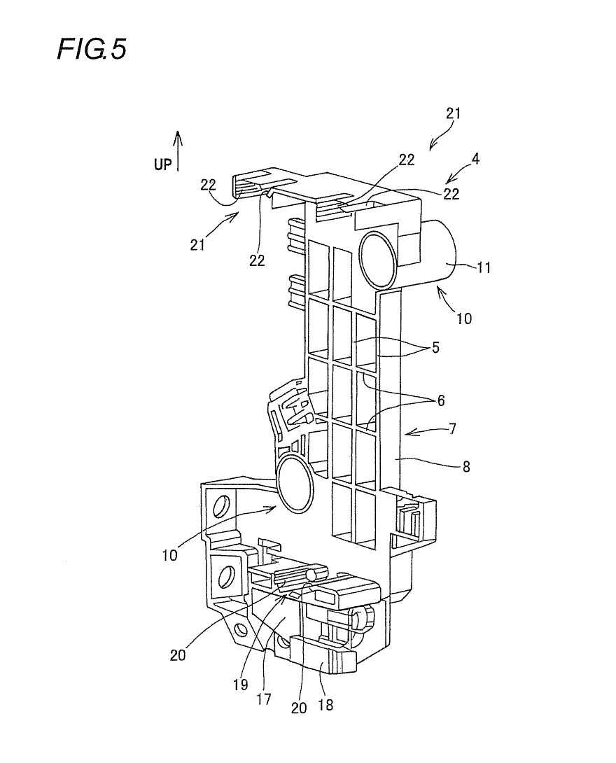

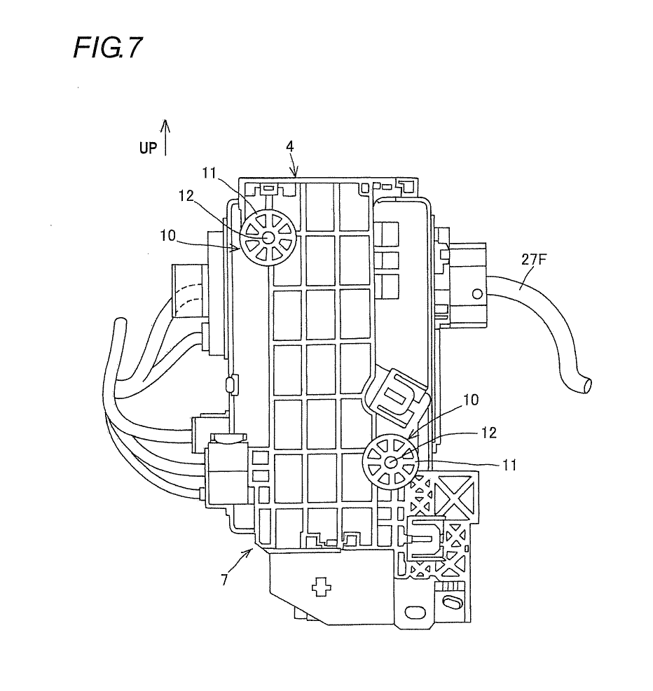

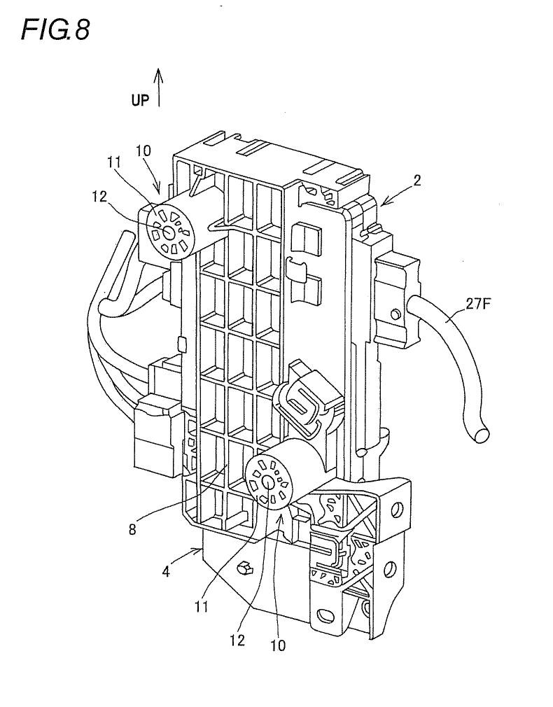

As shown in FIG. 5, the bracket 4 has a bracket main body 7 having combined a plurality of longitudinal materials 5 directed in a vertical direction and a plurality of width- direction materials 6 directed in a horizontal direction. The bracket 4 has a receptacle shape in which a bottom part 8 is formed at a side facing the wall surface 1A of the vehicle interior panel 1 of the bracket main body 7 and a rectangular box accommodation space 9 (refer to FIGS. 1, 3 and 4) is formed at a side spaced from the wall surface 1A of the vehicle interior panel 1. As shown in FIGS. 7 and 8, the bottom part 8 of the bracket 4 is formed at upper and lower parts with a pair of connection parts 10, 10, for example, as a connection part for connecting the bracket 4 and the wall surface 1A of the vehicle interior panel 1 each other. As shown in FIG. 4, the connection parts 10, 10 have leg parts 11, 11, as a leg part for spacing the wall surface 1A of the vehicle interior panel 1 and the bottom part 8 by a predetermined distance L. The connection part 10 has an insertion hole 12 formed in the leg part 11. As shown in FIG. 4, a fixing member (bolt) 13 for fixing the bracket to the wall surface 1A of the vehicle interior panel 1 is inserted into the insertion hole 12. The fixing member 13 has a head part 13A that is engaged with a step part 14 of the insertion hole 12 and a shaft part 13B that passes through a through-hole 15 of the vehicle interior panel 1. An attachment nut 16 is engaged with a leading end of the shaft part 13B.

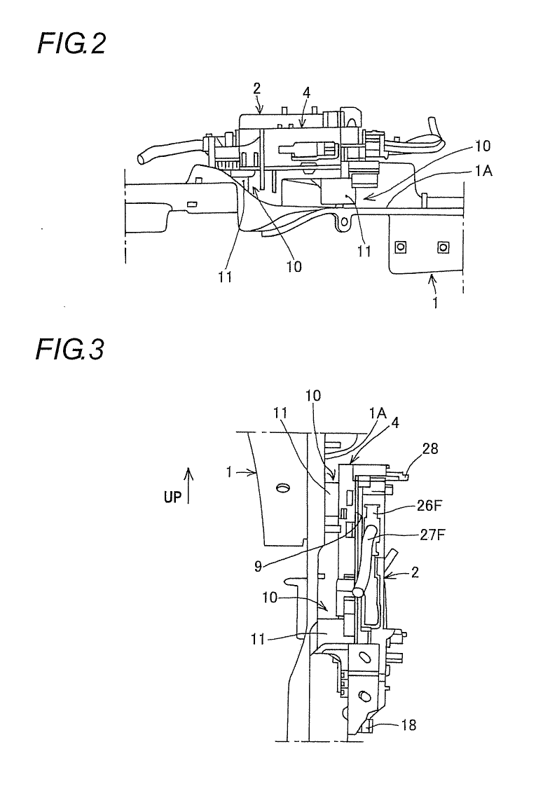

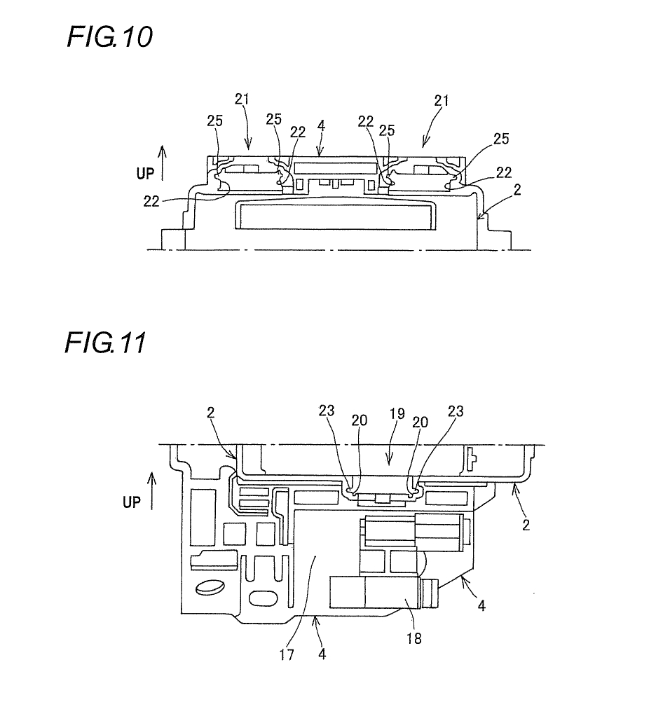

A lower part of the bracket main body 7 of the bracket 4 is formed with a connector holding part 17. The connector holding part 17 is to hold a connector 18 for holding or connecting an electric wire. In this case, as shown in FIG. 2, the connector 18 is arranged to overlap with the bracket 4 or electrical equipment accommodation box 2, when seen from the lower surface. Also, the lower part of the bracket main body 7 of the bracket 4 is formed at a substantially central portion with lower engaging recesses 20, 20 that configure a lower engagement mechanism 19 and extend in the horizontal direction. Furthermore, an upper part of the bracket main body 7 of the bracket 4 is formed at both sides with a pair of upper engagement mechanisms 21, 21. The upper engagement mechanism 21 has upper engaging recesses 22, 22 that extend in the horizontal direction. In the meantime, as shown in FIGS. 1, 3 and 4, the electrical equipment accommodation box 2 has a parallelepiped shape so that it is entirely accommodated in a box accommodation space 9 of the bracket 4. As shown in FIG. 11, a lower part of the electrical equipment accommodation box 2 is formed with lower engaging protrusions 23, 23 that are engaged with the lower engaging recesses 20, 20 of the bracket 4, so as to configure the lower engagement mechanism 19. Also, as shown in FIG. 10, an upper part of the electrical equipment accommodation box 2 is formed with upper engaging protrusions 25, 25 that are engaged with the upper engaging recesses 22, 22 of the bracket 4, so as to configure the upper engagement mechanism 21. Therefore, as shown in FIG. 11, the lower engagement mechanism 19 includes the lower engaging protrusions 23, 23 and the lower engaging recesses 20, 20 that accommodate and are engaged with the lower engaging protrusions 23, 23. Also, as shown in FIG. 10, the upper engagement mechanism 21 includes the upper engaging protrusions 25, 25 and the upper engaging recesses 22, 22 that accommodate and are engaged with the upper engaging protrusions 25, 25.

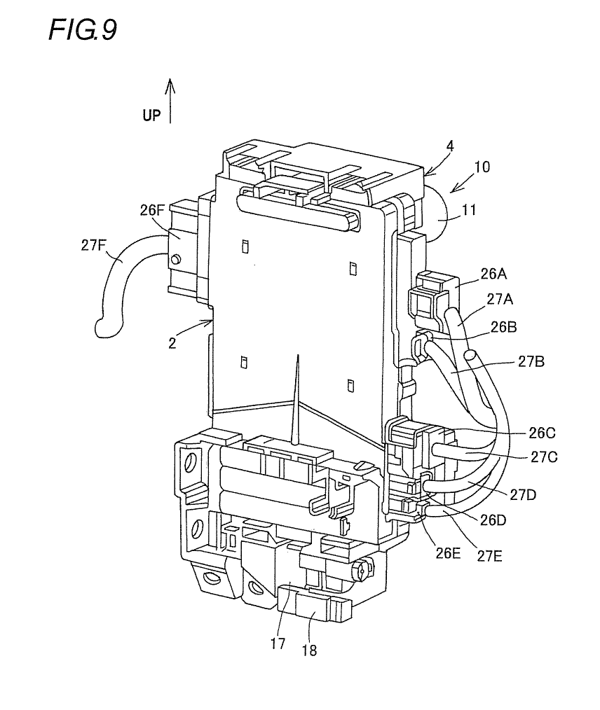

As shown in FIG. 9, first to sixth connectors 26A to 26F are attached to a side of the electrical equipment accommodation box 2. The first to sixth connectors 26A to 26F are connected with first to sixth electric wires (cables) 27A to 27F.

The electrical equipment accommodation box 2 is attached to the wall surface 1A of the vehicle interior panel 1 by the bracket 4, as described below. First, the bracket 4 is attached to the wall surface 1A of the vehicle interior panel 1 by inserting the fixing member 13 into the insertion hole 12 of the connection part 10 and fastening the attachment nut 19 at the leading end of the shaft part 13B. The electrical equipment accommodation box 2 is slidingly moved along the lower engagement mechanism 19 and the upper engagement mechanism 21 of the bracket 4, so that the electrical equipment accommodation box 2 is accommodated in the box accommodation space 9 of the bracket 2. In this case, the electrical equipment accommodation box 2 is fitted and fixed to an inner surface forming the box accommodation space 9 of the bracket 4 and is not separated from the bracket 4 by a frictional force with the inner surface. Also, at this time, the leg parts 11, 11 are provided, so that the electrical equipment accommodation box 2 is spaced from the wall surface 1A of the vehicle interior panel 1 by the distance L, as shown in FIG. 4.

As described above, since the bottom part 8 of the bracket 4 is formed with the connection part 10 for connecting the bracket 4 and the wall surface 1A of the vehicle interior panel 1, it is not necessary to provide a fitting for fixing and the like to a surrounding of the electrical equipment accommodation box 2, so that it is possible to save a space necessary for the attachment structure. Also, the bracket 4 is formed at the lower part with the connector holding part 17 with which the connector 26 for holding or connecting an electric wire is held. As shown in FIGS. 3 and 4, the connector 26 is arranged to overlap with the bracket 4 or electrical equipment accommodation box 2, when seen from the lower surface. With the above configuration, since the connector 26 attached to the connector holding part 17 is arranged at a position at which it overlaps with the bracket 4 or electrical equipment accommodation box 2, when seen from the lower surface, as shown in FIG. 2, the connector is securely protected from water droplets dropping from the upper. Furthermore, the connection part 10 is provided with the leg part 11 for spacing the wall surface 1A of the vehicle interior panel 1 and the bottom part 8 of the bracket 4 each other. With the above configuration, as shown in FIG. 4, since the electrical equipment accommodation box 2 is spaced from the wall surface 1A of the vehicle interior panel 1, the water droplets that are transferred along the wall surface 1A of the vehicle interior panel 1 are prevented from being attached to the electrical equipment accommodation box 2. Also, since the electrical equipment accommodation box 2 is entirely accommodated in the box accommodation space 9 of the bracket 4, the water droplets dropping from the upper are prevented from being introduced into the electrical equipment accommodation box 2. Furthermore, as shown in FIG. 4, the upper part of the electrical equipment accommodation box 2 is provided with a protruding shield part 28. Thereby, the water droplets dropping from the upper are prevented from being introduced into the electrical equipment accommodation box 2.

The attachment structure of the electrical equipment accommodation box according to the invention can be applied to a variety of vehicles.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An attachment structure of an electrical equipment accommodation box in which an electrical equipment accommodation box accommodating therein an electrical component is attached to a wall surface of a vehicle body-side by a bracket,
wherein the bracket has a receptacle shape in which a bottom part is formed at a side facing the wall surface, and
wherein the bottom part of the bracket is provided with a connection part for connecting the bracket and the wall surface to each other.

2. The attachment structure of an electrical equipment accommodation box according to claim 1, wherein the bracket is provided at a lower part with a connector holding part with which a connector for holding or connecting an electric wire is held, and
wherein the connector is arranged to overlap with the bracket or electrical equipment accommodation box, when seen from a lower surface.

3. The attachment structure of an electrical equipment accommodation box according to claim 1, wherein the connection part has a leg part for spacing the wall surface and the bottom part of the bracket from each other.
